(19) United States
(12) Patent Application Publication
(10) Pub. No.: US 2008/0124959 A1
(43) Pub. Date: May 29, 2008

(54) Electrical connector with improved contact

(75) Inventors: Koichi Lino, Yokohama (JP); Guo-Jian Shen, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/998,056

(22) Filed: Nov. 28, 2007

(30) Foreign Application Priority Data
Nov. 28, 2006 (CN) 200610097796.2

(51) Int. Cl. H01R 13/648; H01R 13/40

(52) U.S. Cl. 439/108; 439/607; 439/626; 439/736

(57) ABSTRACT

An electrical connector includes an insulating housing (1) defining a first direction and a plurality of conductive contacts (20) arrayed in the housing along the first direction. The contacts are divided into a first type and a second type and each includes a soldering portion extending out the insulating housing. The soldering portion of the second type is wider than that of the first type and distances between every adjacent soldering portions of the first and second type are the same.

### BACKGROUND OF THE INVENTION

1. Field of the invention

The present invention relates to an electrical connector, especially to an electrical connector with ground contacts or power contacts thereof.

2. Description of Related Art

In high density current connector, a plurality of conductive contacts transferring signal are arrayed parallel in the housing along an elongated direction. Usually, the distance between adjacent contacts is more and more smaller due to miniaturization based on high density. And contacting portions each are wider than corresponding soldering legs so that the contacting portions can reliably engage with mating contacts of a mating connector and the distance between two adjacent soldering legs are enlarged, thereby avoidance of adjoining the adjacent soldering legs by weld raw materials is obtained. Power contact or grounding contacts might be added to optimize signal transfer or the connector, for example, a current connector disclosed in U.S. Pat. No. D505,919. The connector disclosed is provided with power contacts, which is larger than the signal contacts to transfer a larger current. The power contacts stand beside the signal contacts with a larger distance, which will increase the connector. More, the power contacts must be solely produced, which results in increasing cost of production.

Therefore, an improved electrical connector is desired to overcome the disadvantages of the prior arts.

### SUMMARY OF THE INVENTION

An object of the present invention is to provide an electrical connector with improved grounding or power contacts.

In order to achieve above-mentioned object, an electrical connector comprises an insulating housing defining a first direction and a plurality of conductive contacts arrayed in the housing along the first direction. The contacts comprises a first type and a second type and each comprises a soldering portion extending out the insulating housing. The soldering portion of the second type is wider than that of the first type and distances between every adjacent soldering portions of the first and second type are the same.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an exploded perspective view of the electrical connector in accordance with the present invention;

FIG. 2 is a front side perspective view of the connector shown in FIG. 1;

FIG. 3 is a cross-sectional views of FIG. 1 taken along line 3-3;

FIG. 4 is a cross-sectional views of FIG. 1 taken along line 4-4;

FIG. 5 is a bottom side perspective view of the connector;

FIG. 6 is a top elevational view of the connector shown in FIG. 5; and

FIG. 7 is a partly enlarged view of the connector shown in FIG. 6.

### DETAILED DESCRIPTION OF THE INVENTION

Reference will now be made to the drawing figures to describe the preferred embodiment of the present invention in detail.

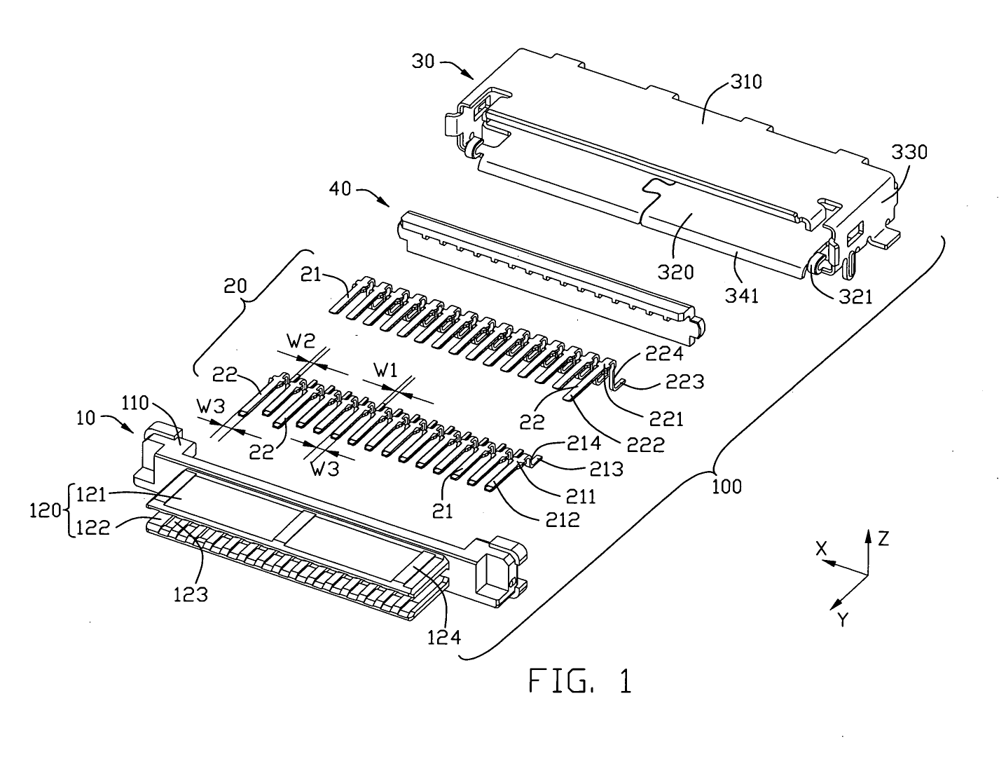

Referring to FIG. 1, an electrical connector 100 in accordance with the present invention comprises an insulating housing 10 with a plurality of conductive contacts 20 assembled therein. A metal shield 30 is assembled to the housing 10 and a stopper 40 is provided at a rear portion of the housing 10.

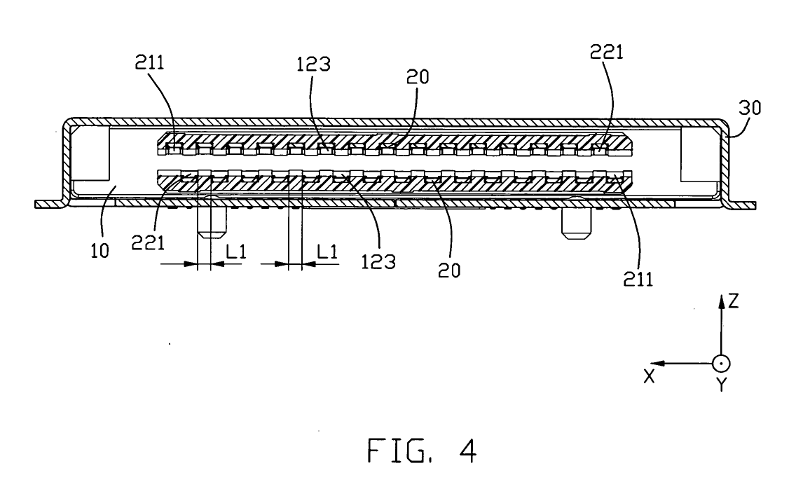

The insulating housing 10 includes an elongated base portion 110 defining a first direction (“X” direction) along the elongated direction and a mating portion 120. The base portion 110 has a front portion and a rear portion in a second direction (“Y” direction) perpendicular to the first direction. The mating portion 120 extends forward from the frond portion of the base portion 110. The mating portion includes an upper tongue 121 and a lower tongue 122 which is in parallel to the upper tongue 121. Two inner surfaces, which are face-to-face, of both the upper tongue 121 and the lower tongue 122 define a plurality of passageways 123 arranged offset and alternatively, see FIG. 4. The external surfaces, which are back-to-face, are provided with ribs 124 so as to prevent the upper and lower tongues from warping thereby ensuring pre-determined coplanarity of the two tongues.

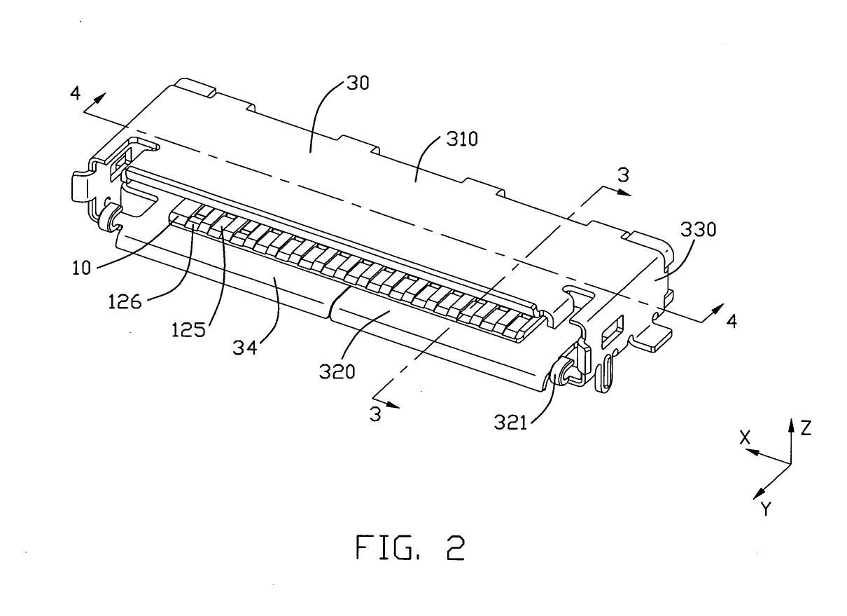

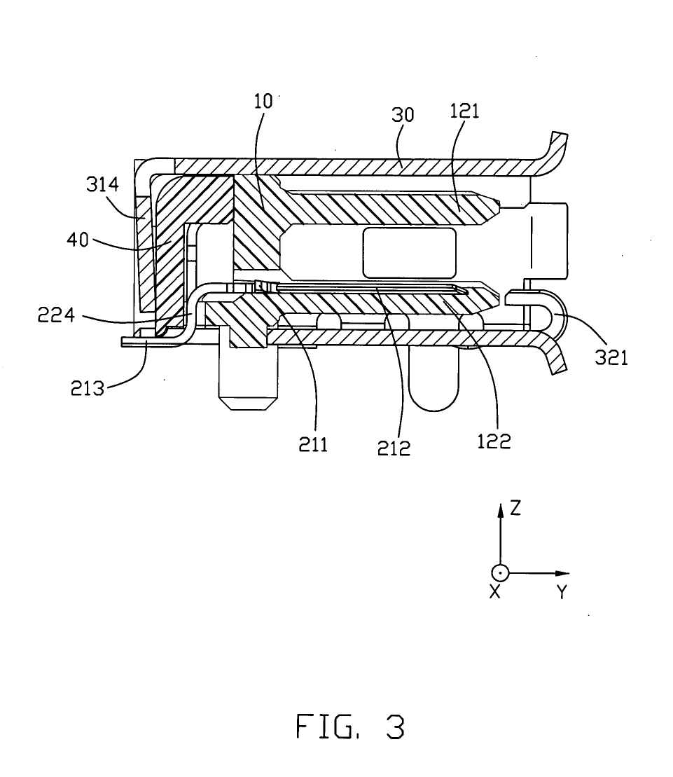

Referring to FIGS. 1 and 3, the plurality of contacts 20 are formed with retaining portions 211/221 secured on the base portion 110 of the housing 10. Each contact 20 further includes a contacting portion 212/222 extending forward from the retaining portion along the corresponding passageway 123 and a soldering portion 213/223 which is interconnected to the retaining portion by a connection portion 214/224. See FIG. 2, a blocking lug 125/126 is in the front of each passage and the lug 125 is longer than the lug 126 being adapted for corresponding contacting portion of the contact. The stopper 40 is assembled on the housing and positioned at the back of the connecting portion.

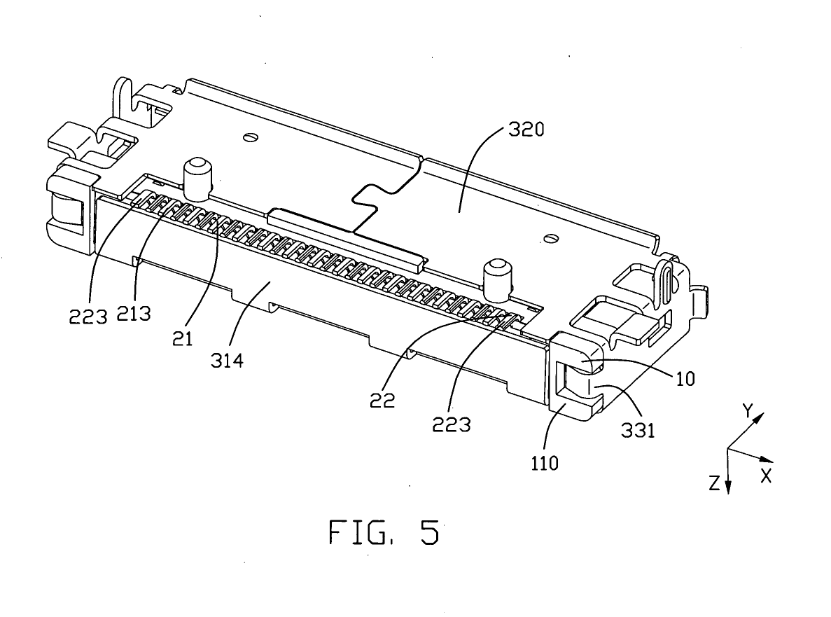

The shield 30 includes an upper wall 310, a lower wall 320 and end walls 330 interconnecting the upper and lower walls 310, 320 thereby forming a frame encapsulating the housing 10. The front edge of the upper and lower walls form with an arc-shaped guiding portion 341 to function as a mating guide of a mating connector. An anti-disorientation arrangement 321 is arranged on a front end of the lower wall 320. An retaining portion 331 (see FIG. 5) is locked at two opposite ends of the base portions of the housing, thereby the shield is secured on the housing. Then a rear flap portion 314 of the upper wall 310 of the shield 30 is bent down right immediate to the stopper 40 to further secure the stopper 40 from detached from the housing 10. More, the stopper 40 blocks the connection portions 214/224 and the rear portion 314 so as to prevent rear portion 314 of the shield from contacting the connection portions 340 such that the short circuit is avoid. The shield 30 is assembled on the housing, thereby forming a mating cavity 34, as best shown in FIG. 2.

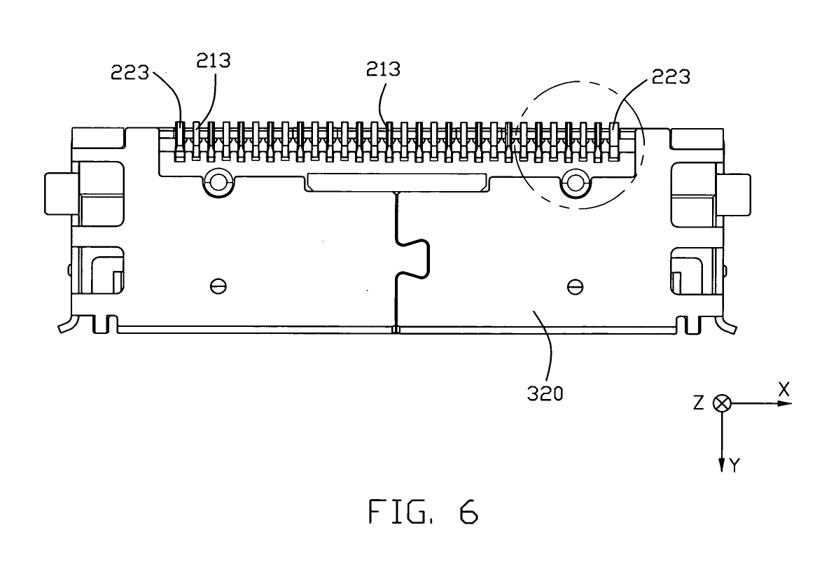

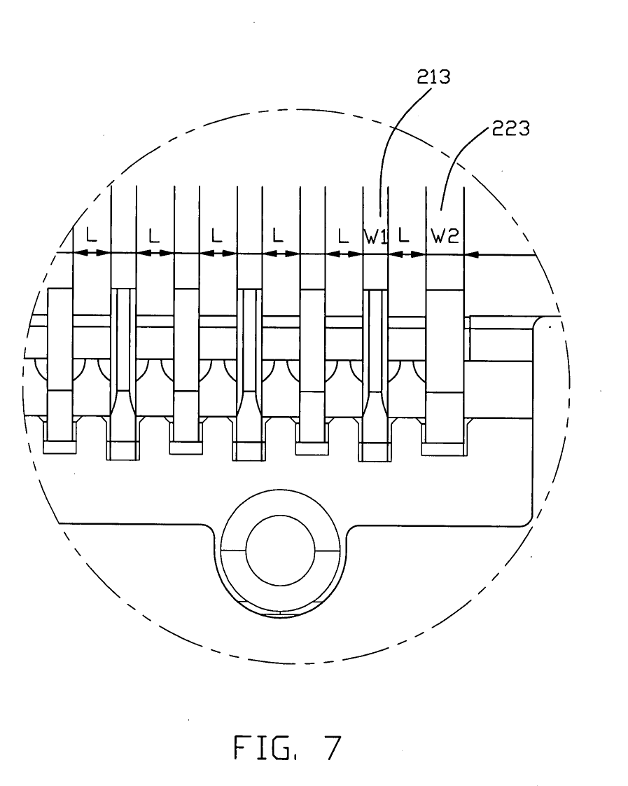

Back to looking at FIG. 1 again, the contacts 20 is arranged in two rows, upper row receiving in the upper tongue 121 and lower row receiving in the row tongue 122. The soldering portions 213, 223 are arrayed in one line, see FIG. 5. Each row of contacts comprises a plurality of contacts 21 of first type transferring signal and one contact of second type 22 transferring power at one end of the row. The two second-type contacts of the upper and lower rows lie in opposite ends respectively. Widths of the contacting portion of the first and second types are the same, designated as W3, but width of the soldering portion of the first type designated as W1 is smaller than that of the second type designated as W2. After the contacts are assembled in the passageways of the housing, the contacting portion of the first and second types are placed with a same distance between adjacent contacts designated as L1 as seen in FIG. 6, and the soldering portions of the first and second types are placed also with a same distance between adjacent contacts designated as L as seen in FIG. 7. Said arrangement of first and second contacts can improve welding effect. More, the two contacts can be formed at same time and assembled in the housing also at same time.

Further, each contacting portion 212 and soldering portion 213 of the first type is of a same central line. Central lines of the contacting portion 221 and the soldering portion 223 of each second-type contact 22 are offset. The central lines of adjacent contacting portions are arrayed with a same distance interval, but the central line of the soldering portion of the second-type contacts 22 is at outside the corresponding central line of the contacting portion. In other word, the soldering portion of the second type is widen by enlarging its outside edge, thereby the soldering portion is improved and the distance between the adjacent soldering portion remains.

However, the disclosure is illustrative only, changes may be made in detail, especially in matter of shape, size, and arrangement of parts within the principles of the invention.

What is claimed is:

1. An electrical connector comprising:
an insulating housing defining a first direction;
a plurality of conductive contacts arrayed in the housing along the first direction, each comprising a soldering portion extending out the insulating housing;
wherein said contacts comprise a first type and a second type, the soldering portion of the second type is wider than that of the first type and distances between every adjacent soldering portions of the first and second types are the same.

2. The electrical connector as described in claim 1, wherein the contact of the second type is at an outside of the contacts of the first type.

3. The electrical connector as described in claim 1, wherein each contact of the first and second type comprises a contacting portion extending into a mating cavity of the connector, widths of the contacting portions in the first direction are the same.

4. The electrical connector as described in claim 1, wherein distances between every adjacent contacting portions of the first and second type are the same.

5. The electrical connector as described in claim 1, wherein the housing comprises a base portion and a mating portion extending forwards in a second direction perpendicular the first direction, the contacting portions of the contacts are on the mating portion and the soldering portion extending out of the base portion.

6. The electrical connector as described in claim 5, wherein the mating portion comprises two tongues parallel to each other and a plurality of passageways are defined on two face-to-face surfaces of the two tongues.

7. The electrical connector as described in claim 5, wherein the passageways are offset.

8. The electrical connector as described in claim 1, further comprising a metal shield assembled on the housing.

9. The electrical connector as described in claim 1, wherein the contact of second type is a power contact.

10. An electrical connector comprising:
an insulating housing defining a first direction;
a plurality of conductive contacts retained in the housing at equal intervals along the first direction, each contact comprising a contacting portion and a soldering portion extending out the insulating housing;
wherein the contacts each have a central line except that at least one contact has a central line of the contacting portion and a central line of the soldering portion, the central line of the soldering portion is at an outside of corresponding central line of the contacting portion.

11. The electrical connector as described in claim 10, wherein the soldering portion of the at least one contact is wider than that of the remainder along the first direction.

12. An electrical connector comprising:
an insulative housing defining two upper and lower mating tongues opposite and parallel to each other and commonly exposed in a same mating port; and
first and second sets of contacts disposed in the housing, each of said contacts defining a contacting section and a solder section; wherein
the contacting section of the first set of contacts are positioned on one of the upper mating tongue and the lower mating tongue, and the contacting section of the second set of contacts are positioned on the other of the upper mating tongue and the lower mating tongue under a condition that a width of the contacting section of each of the first set of contacts is essentially equal to that of the contacting section of each of the second set of contacts; wherein
the soldering sections of the first set of contacts and those of the second set of contacts are alternately arranged in one row under a condition that a width of each of the soldering sections of the first set of contacts is larger than that of the soldering section of each of the second set of contacts, while a distance between the neighboring soldering sections of the every adjacent two contacts keeps essentially the same throughout all said one row.
